(19) United States
(12) Patent Application Publication
(10) Pub. No.: US 2025/0346428 A1
(43) Pub. Date: Nov. 13, 2025

(54) NOVEL GRAVITY CONVEYOR FOR AN AUTOMATED COOKING RESTAURANT (ACR)

(71) Applicant: KITCHEN ROBOTICS LTD, Modiin (IL)

(72) Inventors: Nikolay Soldatenko, Kiryat ONO (IL); Yair Gordin, Modiin (IL); David Ben-David, Rehovot (IL)

(73) Assignee: KITCHEN ROBOTICS LTD, Modiin (IL)

(21) Appl. No.: 18/656,793

(22) Filed: May 7, 2024

(51) Int. Cl. B65G 1/08; F16C 19/06; F16C 33/78

(52) U.S. Cl. CPC B65G 1/08; F16C 19/06; F16C 33/7823

(57) ABSTRACT

A gravity-conveyor that is associated with an automated-cooking-restaurant (ACR) is disclosed. An example of the gravity-conveyor may comprise a plate having a plurality of openings and a plurality of sealed-bearings. Wherein each sealed-bearing is associated with an opening from the plurality of openings and wherein each sealed-bearing is caught to the plate by two or more rods that are related to the associated opening in which the sealed-bearing is located.

### FIELD OF THE DISCLOSURE

The present disclosure relates to the field of an automated-cooking-restaurant (ACR) and more particularly the disclosure relates to a novel technique for conveying a cooking device, such as but not limited to a pot, between different stations of an ACR. Along the present disclosure and the claims the term pot may be used as representative term for any type of a cooking device.

### BACKGROUND

A common automated-cooking-restaurant (ACR) has several stations. Stations such as but not limited to a food-ingredients-dispenser, a cooking station, a servicing station, a washing station, a drying station, etc. In order to move a pot from one station to the other some ACRs may use a robotic-arm, a conveyor with an electrical motor a gravity conveyor, or a combination of those.

Some conveyors need to have a shape of an arc. A conveyor that delivers a pot, with a ready dish, from the cooking station to the servicing station may have a shape of an arc, for example. The arc is used in order to deliver the pot toward an operator. The operator may transfer the cooked food from the pot to a dish. The dirty pot can be placed on a gravity conveyor in order to be moved toward the washing station. The dish with the ready food can be delivered to the servicing counter.

An ACR, which uses induction heating for cooking the food ingredients, requires that the pot will be made of iron. Thus, the pot itself is heavy and with the food ingredients the pot is even heavier. When the hot pot is placed over the conveyor an impact is generated over conveyor. Consequently, there is a need for a gravity conveyor that will be robust.

Further, since the novel conveyor is part of an ACR that prepares food it has to comply with regulations that are related to food manufactures such as but not limited to the National-Sanitation-Foundation-International (NSF-International). Among a plurality of requirements the regulations defines cleaning procedure as well as constructing requirements. The regulations requires that elements of the conveyor will be built in a way that will not collect dirt, bearings need to be sealed, screws are not allowed to be exposed, threads have to be blocked, etc. In general the regulations do not recommend using screws, because a screw may be released and falls into a pot with food ingredients.

### BRIEF SUMMARY

The needs and the deficiencies that are described above are not intended to limit the scope of the inventive concepts of the present disclosure in any manner. The needs are presented for illustration only. The disclosure is directed to a novel technique for conveying cooking device, such as but not limited to a pot, a vessel, etc.

An example embodiment of the disclosed technique may comprise a gravity-conveyor (GCon). A GCon is a conveyor in which the force of gravity is used in order to convey a device from a first place to a second place, wherein the first place is higher than the second place. Thus, the device is moved by the gravitational force.

Some example embodiments of the disclosed technique may comprise a robust panel and a plurality of sealed bearing. An example of sealed bearing may be a sealed-ball-bearing (SBB). Other example embodiment of the disclosed technique may use sealed-roller-bearing. Along the disclosure and the claims the term SBB may be used as a representative term for any type of sealed bearing.

The panel can be made of metal and may have a plurality of openings. In some example embodiment the opening may have a shape of rectangle. Other embodiments may use opening having shape such as but not limited to a square or an ellipse, for example. Along the present discloser and the claims the term a rectangular openings can be used as representative term for this group of shapes. One side of the opening is associated with two or more rods. Some example embodiments of the gravity conveyor may have two rods. Other example embodiments may have three rods, etc.

The two or more rods are configured to be associated with the SBB. The dimensions of the rods are adapted to the inner ring of the SBB in a way that enables the SBB to be sliding over the rods in order to be associated with the metal panel. After sliding the SBB over the two or more rods, the rods can be bent away from each other in order to catch the SBB to a plate of the gravity-conveyor. The plate can be made of metal. In this position the outer ring of the SBB is able to revolve while carrying a cooking device, a pot, for example.

The rods are substantially perpendicular to the course of the movement of the cooking device over the opening that contains the rods. In some example embodiment of the disclosed gravity-conveyor the angle between the rods and the course of the movement of the cooking device can be in the range between 80 to 100 degrees. Some examples of the rods are configured to bend more than one time.

An example of a metal plate can be made of steel and may have a thickness of 2 to 10 m″m, 3 m″m for example. The size of an example rectangle opening can be in the range of 20×25 m″m, for example. The length of a rod can be in the range of 7-10 m″m, for example. An example of SBB can be NSK 6800 DDU or NSK 6800 VV, wherein NSK is a Japanese company. When a conveyor has a shape of an arc the opening and the rods are directed toward the center of the arc. Manufacturing of the metal plate with the openings and the rods can be done by laser cutting, for example. Other embodiments may use a computerized-numerical-control (CNC) machine, or similar devices.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates an example of a base of a gravity-conveyor before inserting the SBBs;

FIG. 2 schematically illustrates a portion of an example of a metal plate with few SBBs before catching them to place;

FIG. 3 schematically illustrates a portion of an example of a metal plate with few SBBs after catching them to place; and

FIG. 4 schematically illustrates an example of a gravity conveyor having an arc.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” may be used interchangeably. Anything designated as a unit or an element may be a stand-alone unit or a specialized or integrated element. A unit or an element may be modular or have modular aspects allowing it to be easily removed and replaced with another similar unit or module. In addition the terms element and section can be used interchangeably.

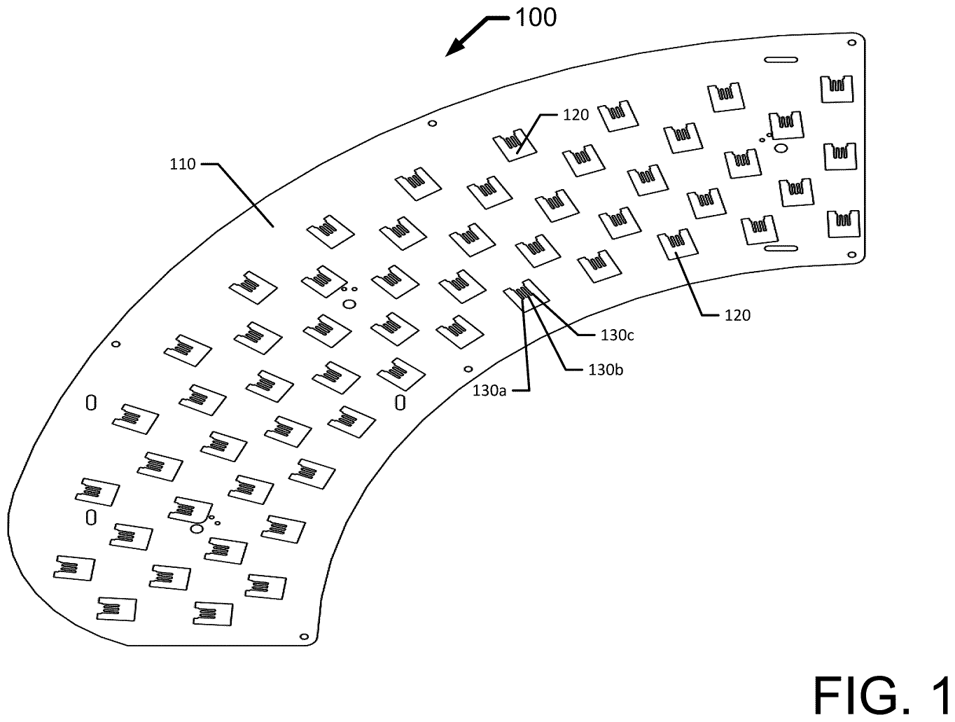

FIG. 1 schematically illustrates an example of a base 100 of an example of a gravity conveyor before inserting the SBBs. Base 100 may comprise a metal-plate 110 having a plurality of rectangular openings 120 wherein each rectangular opening 120 is associated with two or more rods. In this example three rods 130a-c are demonstrated. Some examples of base 100 can be manufactured by a laser cutting machine. Other examples of base 100 can be manufactured by a computerized-numerical-control (CNC) machine, or by any other similar device. Plate 110 can be made of metal. Other example embodiments of base 100 may have opening having shape of a square or an ellipse, for example.

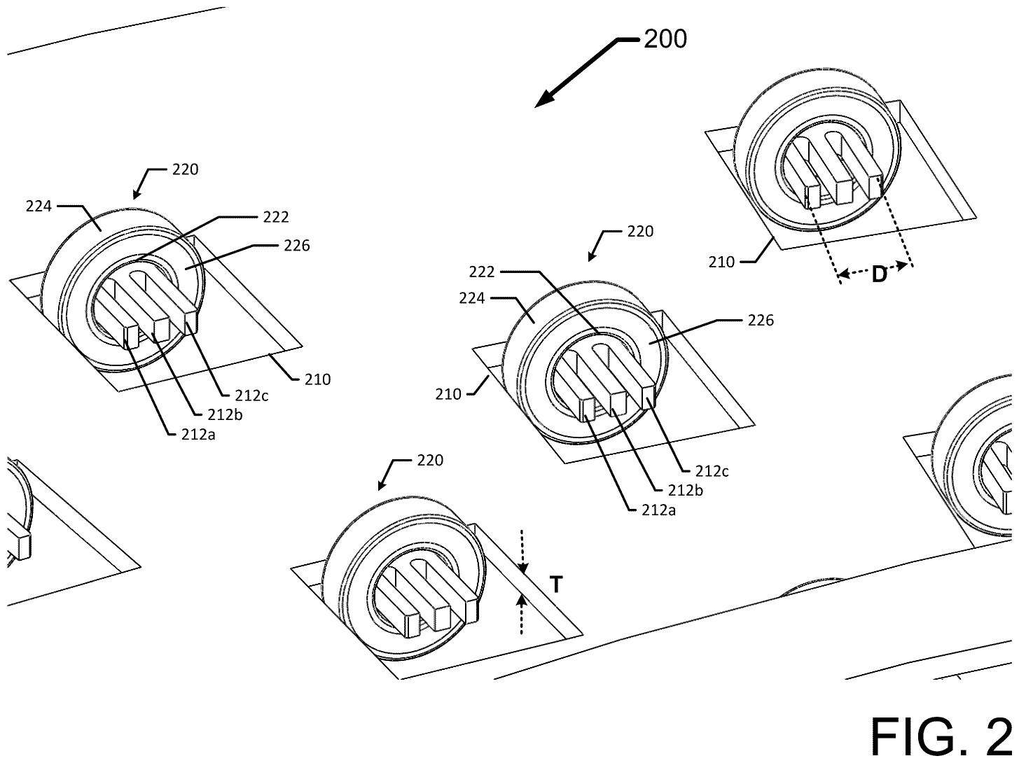

FIG. 2 illustrates a portion of an example of a metal plate 200 having few SBBs 220. Each SBB 220 is placed in an opening 210 around the relevant rods 212a-c. Other example embodiments of the disclosed technique (not shown in the figures) may have two rods instead of three rods. The thickness ‘T’ of the example metal plate 200 can be in the range of 2 to 10 m″m, 3 m″m for example.

The dimension ‘D’ of the three rods 212a-c can be designed to match the diameter of the inner ring 222 of the SBB 220 for allowing the SBB 220 to be sliding over the rods 212a-c in order to be associated with the metal panel. 200. The diameter of the inner ring 222 can be longer than ‘D’ by 0.2 to 1 m″m, for example. A common value can be 0.5 m″m.

The outer ring 224 of the SBB 220 can be revolved while carrying a cooking device such as but not limited to a pot. Each SSB 220 is sealed by two rings 226, one on each side of SBB 220. In FIG. 2 only one ring 226 is presented, the other ring is in the other side of the SBB 220 and therefore cannot be seen. The rings 226 can be made of metal, for example. An example of SBB 220 can be NSK 6800 DDU or NSK 6800 VV, wherein NSK is a Japanese company.

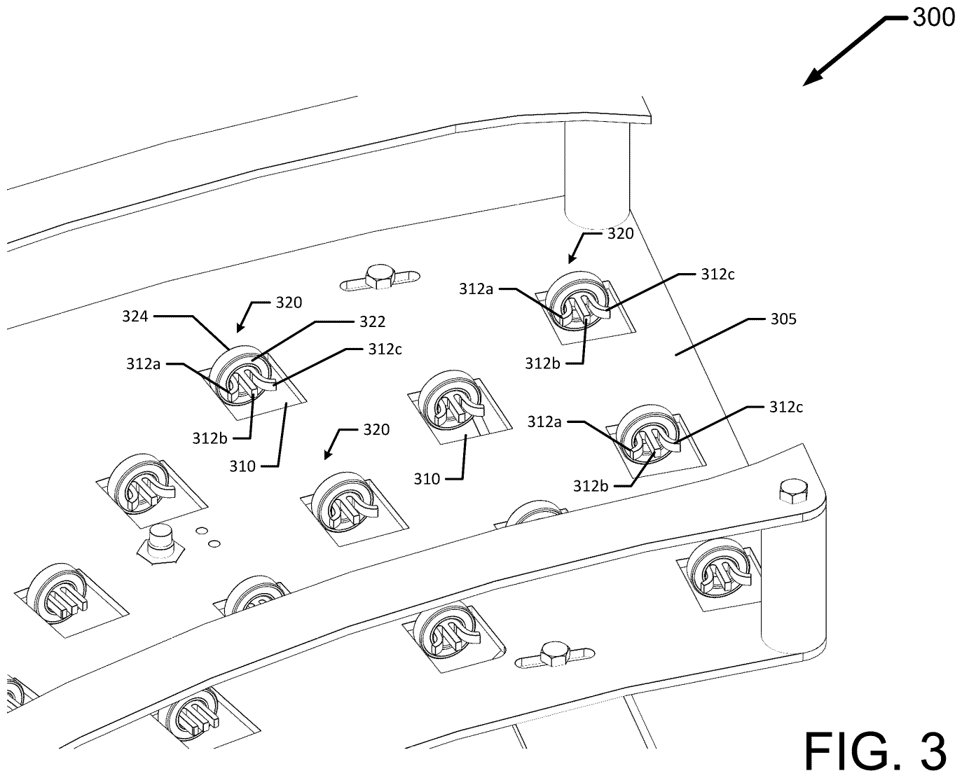

FIG. 3 schematically illustrates a portion of an example of a portion of a gravity-conveyor 300. Gravity-conveyor 300 may comprise a metal plate 305 that is associated with a plurality of SBBs 320. Wherein each SBB 320 is caught to its place in the appropriate opening 310. Catching an SBB 320 to its location can be done by placing a screwdriver in the gap between rod 312a and rod 312b and turning the screwdriver until rod 312a is bent. Then the screwdriver can be placed in the gap between rod 312b and rod 312c and turning the screwdriver until rod 312c is bent. In some cases a knife or other tool can be used instead of the screwdriver.

By bending rod 312a and 312c the inner ring 322 of SBB 320 is caught to its place in the appropriate opening 310. After catching the inner ring 322 to its location, the outer ring 324 is free to revolve and to carry a cooking device along the conveyor 300. Some examples of rods 312a-c are able to be bent several times allowing an operator to replace a defective SBB.

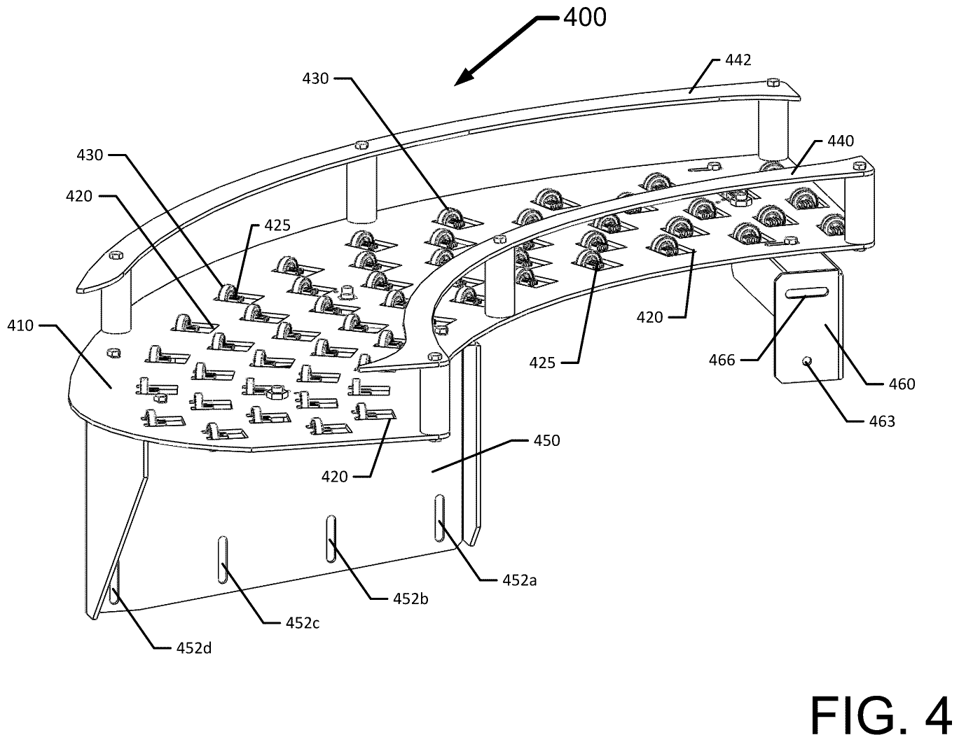

Referring now to FIG. 4 that illustrates an example of a gravity conveyor 400 having an arc. The gravity conveyor 400 may comprise a metal plate 410 can be cut by a laser cutting machine in a shape of an arc. Plate 410 may have a plurality of openings 420 wherein each opening 420 is associated with three rods 425. The rods 425 of are substantially perpendicular to the course of the movement of the cooking device over the relevant opening. In some example embodiment of the disclosed gravity-conveyor 400 the angle between the rods 425 and the course of the movement of the cooking device, over the relevant opening, can be in the range between 80 to 100 degrees. This property is demonstrated by the rods 425 of the openings 420, which are located in the arc. Those rods 425 are targeted toward the center of the arc (the center is not shown in the figure). Thus, forcing the cooking device which is sliding over the SBB 430 along the conveyor 400, to turn along the arc.

In example embodiments of Gravity conveyor 400 the metal plate 410 can be carried over two panels, a front panel 450 and a back panel 460. The front panel 450 has a plurality of vertical slots 452a-d. While the back panel 460 has a hole 463 and a horizontal slot 466.

When associating the Gravity conveyor 400 to an ACR (not shown in the figures) the back panel 460 can be attached to the ACR by a screw that penetrates hole 463 as a pivot that allows the adjusting of the slope of the metal plate 410. A second screw can penetrate the horizontal slot 466 and be used for locking the back panel to the ACR in an appropriate angle.

The front panel 450 can be attached to the ACR by a four screws that penetrates the vertical slots 452a-d. Other example embodiment of the disclosed technique may use other number of screws. The vertical slots 452a-d can be used in order to adjust the height of the exit of the Gravity conveyor 400. Thus, by using hole 463, slot 466 and slots 452a-d an operator can adjust the slope of the metal plate 410 in order to control the speed of the cooking device that is sliding along the Gravity conveyor 400. Some example embodiments of a Gravity conveyor 400 may comprise two railings 440 and 442 in order to avoid falling of the cooking device.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

We claim:

1. A gravity-conveyor that is associated with an automated-cooking-restaurant (ACR), the gravity-conveyor comprising:
i. a plate having a plurality of openings;
ii. a plurality of sealed-bearings;
iii. wherein each sealed-bearing is associated with an opening from the plurality of openings; and
iv. wherein each sealed-bearing is caught to the plate by two or more rods that are related to the opening in which the sealed-bearing is located.

2. The gravity-conveyor of claim 1, wherein the sealed-bearings is a sealed-ball-bearings (SBB).

3. The gravity-conveyor of claim 1, wherein the plate is made of metal.

4. The gravity-conveyor of claim 1, wherein the two or more rods are substantially perpendicular to the course of the movement of a cooking device over the opening that comprises the two or more rods.

5. The gravity-conveyor of claim 1, wherein the angle between the two or more rods and the course of the movement of the cooking device is between 80 to 100 degrees.

6. The gravity-conveyor of claim 2, wherein at least one SBB from the plurality of SBB is NSK 6800 DDU.

7. The gravity-conveyor of claim 1, wherein the dimensions of the two or more rods are designed to match the diameter of an inner ring of the sealed-bearing.

8. The gravity-conveyor of claim 1, wherein at least one sealed-bearing from the plurality of sealed-bearings has been slid over the two or more rods of the associated opening in which the sealed-bearing is located.

9. The gravity-conveyor of claim 8, wherein at least two from the two or more rods are bent for catching the sealed-bearing to the plate.

10. The gravity-conveyor of claim 1, wherein the plate has an arc, the two or more rods are directed toward the center of the arc.

11. The gravity-conveyor of claim 1, wherein the plate is attached to an ACR by a front-panel and a back-panel.

12. The gravity-conveyor of claim 11, wherein the front panel has a plurality of vertical slots.

13. The gravity-conveyor of claim 11, wherein the back panel has a hole and a horizontal slot.

14. The gravity-conveyor of claim 11, wherein the front-panel and the back-panel enable the adjustment of the slope of the plate.

15. The gravity-conveyor of claim 1, wherein at least one rod is able to be bent two or more times.
